(19) United States
(12) Patent Application Publication
(10) Pub. No.: US 2004/0046290 A1
(43) Pub. Date: Mar. 11, 2004

(54) Microchannel fabrication

(76) Inventors: Byung Kim, Amherst, MA (US); Donggang Yao, Rochester Hills, MI (US)

Correspondence Address: Byung Kim, 23 Woodlot Rd., Amherst, MA, 01002, US

(21) Appl. No.: 10/236,852

(22) Filed: Sep. 6, 2002

(51) Int. Cl. B29D 24/00

(52) U.S. Cl. 264/500; 264/548

(57) ABSTRACT

A design of microchannels and a method for economic production of such microchannels. The new microchannel design comprises a thin thermoplastic film and a relatively thick substrate to form microchannels in-between. The microchannels are displaced on the film side. The method for fabricating such microchannels is a hybrid process combining compression, and blowing or vacuum forming to form microchannels between the film and the substrate. During the process, the film is placed on the top of the substrate. A mold or die with to-be-replicated microchannels clamps the film against the substrate. Either blow molding or vacuum forming is then carried out to deform the film and replicate the microchannels. Rapid heatable and coolable molds are preferred to soften the film and form bonds between the film and the substrate while short cycle time is maintained.

### STATEMENT REGARDING FEDERALLY SPONSORED RESEARCH OR DEVELOPMENT

Research leading to the invention disclosed and claimed herein was supported in part by the National Science Foundation, NSF Grant No. DMI-9713519. The U.S. Government may have certain rights to the invention.

### CROSS-REFERENCE TO RELATED APPLICATIONS

This invention relates in part to the pending application entitled “Method and Apparatus for Rapid Mold Heating and Cooling,” with inventors Byung Kim and Donggang Yao, filed on Sep. 4, 2002.

### BACKGROUND

1. Field of Invention

The field of the invention pertains to microstructure fabrication using thermoplastic materials, and in particular provides a new micromolding method for rapidly fabricating microchannels using thermoplastics.

In the description of the invention, microchannels are defined as channels with characteristic lateral dimension fallen between a tens of one micron to several millimeters. A thermoplastic material is defined as a material which softens upon heating and hardens again upon cooling, such as thermoplastic polymers.

2. Description of Prior Art

Microchannels are desired in many miniaturized devices. Particularly in biomedical applications, microchannels are used as delivering/branching/sorting systems for immunodiagnostics, genomics, drug delivery, DNA microelectrophoresis, etc.

Most of the currently fabricated micro-devices are the result of reliable production technology and know-how adopted from the semiconductor industry, which has well-established micro fabrication methods such as lithography and etching. The drawback of these silicon-based methods, however, is their relatively slow rate and costly production. Compared to silicon based materials, polymeric materials have considerable advantages for biomedical applications. There are more than several thousand different types of polymeric materials available for designers to choose. Their properties are very versatile, and desired mechanical, chemical, optical and electrical functions for bio-MEMs and bio-chips can thus be achieved with polymeric materials. One example is hydrophobic microfluidic systems. Silicon is hydrophilic and so cannot be used in this case, while several highly hydrophobic polymers such as Teflon and PDMS (polydimethylsiloxane) can perfectly realize the hydrophobic function. For applications in implantation, extracorporeal surgery and medicine, many different types of biocompatible polymers are available. As to the environmental issues, cheap and biodegradable polymers such as polylacticacid and polycaprolactone are also accessible. Furthermore, there are many low-cost mass-production manufacturing methods available for processing polymeric materials, such as injection molding, compression molding, extrusion, thermoforming, etc. With proper modifications, these standard processing methods could be adapted to microfabrication. Although plastic parts have so far played only a subordinate role in silicon-based micro products, they have begun to show great commercial potential in the fledgling field of microstructured products for medical technology and biotechnology.

For prototyping purpose, polymer-based micro devices can be fabricated using lithographical methods and precision engineering methods. Particularly, X-ray lithography, UV lithography and laser machining have been successfully used to micromachine polymers. A more detailed description of the current technology for micromachining polymeric materials can be found on pages 275 through 365 in Madou's book entitled “Fundamentals of Microfabrication” published by CRC Press LLC in 1997. Because the actual production scale of polymer-based products in biomedical and telecommunication applications is very large, low-cost mass-production is highly desired.

The conventional technology for processing thermoplastics is well established, such as injection molding, compression molding, blow molding, thermoforming, and so forth. With proper modification of hardware and processing strategies, these manufacturing processes can be adapted to microstructure fabrication. Over the past few years, the injection molding process and the compression molding process have been successfully applied to microstructure replication on thermoplastic materials, resulting in the micro injection molding technology and the hot embossing technology. Detail about micro injection molding can be found in the article by Benzler et al., entitled “Innovations in Molding Technologies for Microfabrication”, pages 53 through 60, SPIE, 1999. Detail about hot embossing can be found in the article by Becker and Heim, entitled “Hot Embossing as a Method for Fabrication of Polymer High Aspect Ratio Structures”, pages 130 through 135, Sensors an Actuators, Volume 83, 2000, and another article by Juang, Lee and Koelling, entitled “Hot Embossing in Microfabrication”, pages 539 through 550, Polymer Engineering and Science, Volume 42, March 2002.

In a thermoplastic micromolding process, a molten or softened polymeric material is delivered to the die area for bulk deformation and flow under pressure work, solidified under cooling, and finally ejected out of the mold. The primary difficulty in molding microstructures is that the molten polymer at the entrance of microstructures will instantaneously freeze upon contacting the relatively cold mold wall due to rapid thermal diffusion across a very thin section. The problem becomes worse when high-aspect-ratio microstructures are to be replicated. In order to alleviate the freezing problem, the mold temperature has to be raised. For example, in the hot embossing process, the mold temperature is typically set to a temperature slightly above the polymer softening temperature (glass transition temperature for amorphous polymer or melting temperature for crystalline polymer). After the material is embossed on the die pattern, the entire molding including both the die and the part are cooled. Because an elevated mold temperature is employed, the cycle time for hot embossing can be as long as 5 minutes or above. For micro injection molding, investigations also indicated that elevated mold temperatures are needed for good replication of microstructures. Despa, Kelly and Collier in their article, “Injection molding using high aspect ratio microstructures mold inserts produced by LIGA techniques”, Pages 286 through 294, SPIE, 1998, reported that for HDPE a mold temperature above the melting point of HDPE favors the complete penetration into microvoids, preventing the melt from prematurely freezing. Wimberger-Friedl in his article, “Injection molding of sub-μm grating optical elements”, Pages 78 though 83, Journal of Injection Molding Technology, 2000, reported that, for good replication of sub-μm grating optical elements using polycarbonate, a mold temperature above the glass transition temperature of polycarbonate is needed. Employment of elevated mold temperature, however, results in intolerably long cycle time. For rapid production using micro injection molding and hot embossing, rapid cycling of the mold temperature is crucial.

Our pending patent application entitled “Method and Apparatus for Rapid Mold Heating and Cooling,” filed on Sep. 4, 2002, disclosed a rapid heating and cooling method using radio frequency or high frequency proximity heating. The mold surface with proximity heating can be rapidly heated from room temperature to above the softening temperature of the molding material and then cooled rapidly within normal molding cycle time. With this rapid heating and cooling technology, the long cycle time in micro injection molding and hot embossing can be greatly reduced.

Microchannels fabricated via micro injection molding and hot embossing are open channels, as shown in FIG. 1. As a result, a cover piece is needed to cover the molded channels and form closed microchannels. Typically, the cover piece is adhesive-bonded to the molded part. In this patent application, we disclose a novel microchannel design and a new micromolding method for fabrication such microchannels. Microchannels produced by this new method are closed channels. With the employment of novel designs and judicious processing strategies in this new method, rapid and net-shape production of closed microchannels can be achieved.

### SUMMARY OF THE INVENTION

The present invention provides a new design of microchannels and a method for economical production of such microchannels. The new microchannel design comprises a thin plastic film and a relatively thick substrate to form microchannels in-between. The microchannels are displaced on the film side. The method for fabricating such microchannels is a hybrid process combining compression, and blowing or vacuum forming to form microchannels between the film and the substrate. During the process, the film is placed on the top of the substrate. A mold or die with to-be-replicated microchannels clamps the film against the substrate. Either blow molding or vacuum forming is then carried out to deform the film and replicate the microchannels.

This new microchannel fabrication method prefers to use an elevated mold temperature to soften the film for forming and soften the contacting area between the film and the substrate for fusion bonding. To reduce the elongated cycle time due to the heated mold, rapidly heatable and coolable molds are preferred. There are several variations to the actual embodiment of the method, depending on how the mold is heated and cooled and when the heat is applied to the film.

The invention provides a mean for low-cost mass-production of net-shape microchannels. Microchannels produced with this invention are closed channels, and therefore secondary cover pieces can be eliminated. The so-fabricated plastic microchannels can be used as microfluidic channels for biomedical applications.

### OBJECTS AND ADVANTAGES

Accordingly, several objectives of this invention are:

An objective of this invention is to provide a method for economically producing microchannels with plastic materials.

Another objective of this invention is to provide a method to shorten the cycle time in microchannel fabrication.

A further objective of this invention is to provide a unique design of microchannels which is formed between a plastic film and a relatively thick substrate.

Further objects and advantages of this invention will become apparent from a consideration of the drawings and ensuing description.

### DESCRIPTION OF THE DRAWINGS

The subject matter which is regarded as the invention is particularly pointed out and distinctly claimed in the concluding portion of the specification. The invention, however, may be best understood by reference to the following description taken in conjunction with the accompanying drawing figures in which:

FIG. 1 shows open channels produced by either micro injection molding or hot embossing.

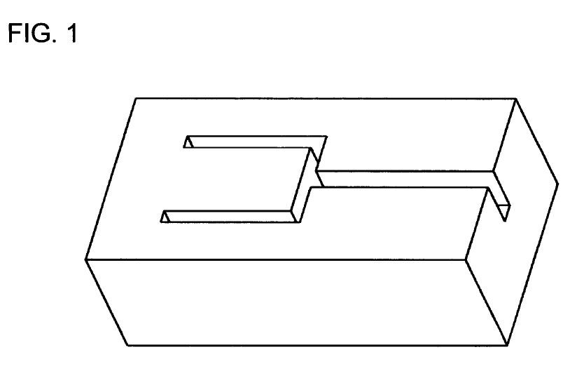

FIG. 2 shows a design for a straight closed microchannel.

FIG. 3 shows a design for a U-shaped closed microchannel.

FIG. 4 schematically illustrates the present method for fabricating microchannels.

FIG. 5 shows a mold piece with a straight microchannel.

FIG. 6 schematically illustrates an embodiment to the present method for fabricating microchannels.

FIG. 7 schematically illustrates the preferable embodiment to the present method for fabricating microchannels when a rapidly heatable and coolable mold is employed.

### DESCRIPTION OF THE INVENTION

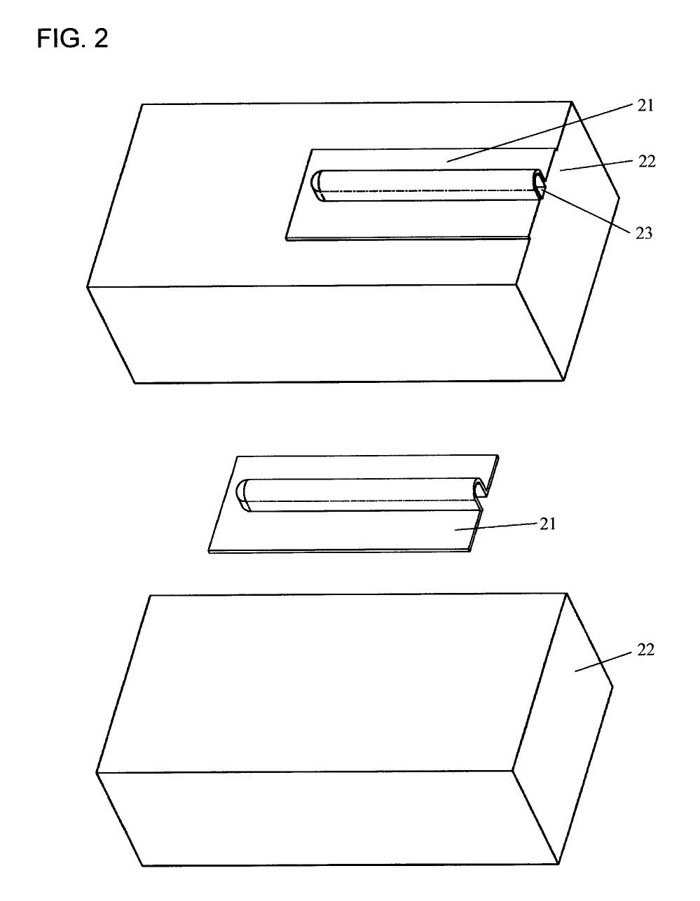

FIG. 2 shows the design of a straight closed microchannel. The straight closed microchannel 23 is formed between a plastic film 21 and a relatively thick substrate 22. The preferable material for 22 is thermoplastic.

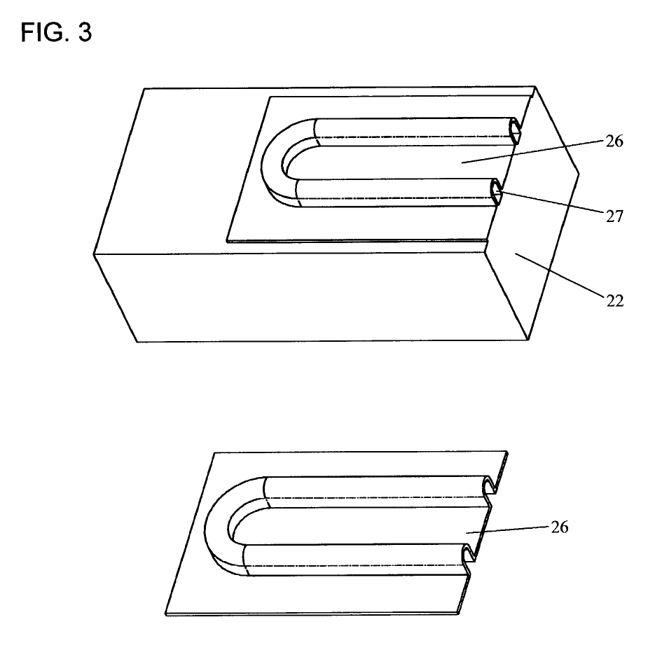

FIG. 3 shows the design of a U-shape closed microchannel. The U-shape closed microchannel 27 is formed between a plastic film 26 and substrate 22.

In the same way, more complicated closed microchannels can be designed. The thin thermoplastic film has thickness from a micron to a fraction of a millimeter. It has microchannels on the substrate side, thus forming closed microchannels between the film and the substrate. The layout of microchannels is designed according to actual microfluidic applications. The surface of the substrate is not necessarily flat and general contours can be used by mating the film with the substrate. The shape of the cross section of microchannels can be trapezoidal, rectangular, semicircular, or any other shapes. Microchannels designed in this way can have high aspect ratios, i.e. high ratio of channel depth against channel width.

The microchanneled film and the substrate in the above design can be manufactured using two separated processes and then assembled together by adhesion bonding. For example, the microchanneled film can be produced by thermoforming and the substrate can be produced by injection molding. The bonding between the two components can be formed subsequently using adhesives, solvation, thermal fusion, etc. Because of the difficulty in binding the microchanneled film with the substrate, this sequential approach as described above is difficult.

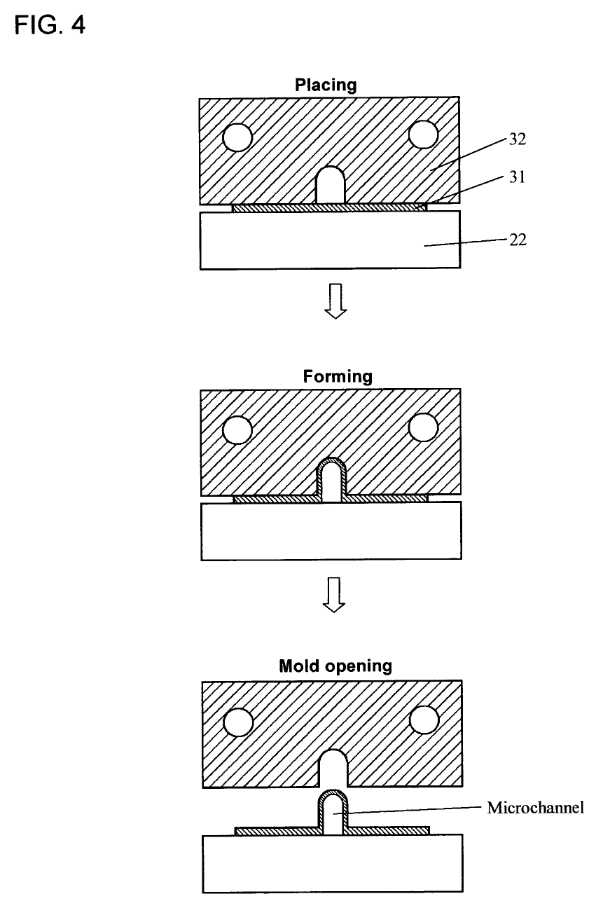

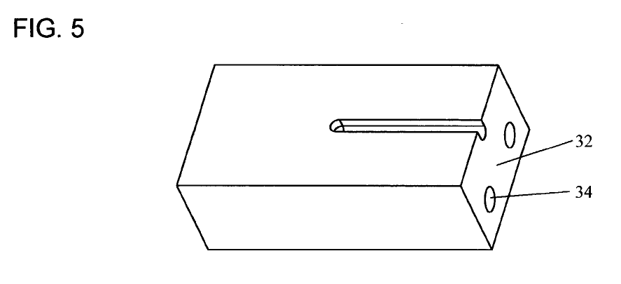

FIG. 4 shows an integrated manufacturing process for fabricating closed microchannels with the design as illustrated in FIG. 2 and FIG. 3. This method is a hybrid process combining compression, and blowing or vacuum forming to form microchannels between the film and the substrate. During the process, a film blank 31 is placed on the top of substrate 22. A mold or die 32 with to-be-replicated microchannels clamps the film blank 31 against the substrate. Either blow molding or vacuum forming is then carried out to deform the film and replicate the microchannels. The isometric view of the microchanneled mold 32 with a straight microchannel is shown in FIG. 5. Coolant channels 34 are optionally built in the mold for increased cooling. Actual embodiments to the process shown in FIG. 4 need additional means for softening film blank 31 and forming bonds between film blank 31 and substrate 22.

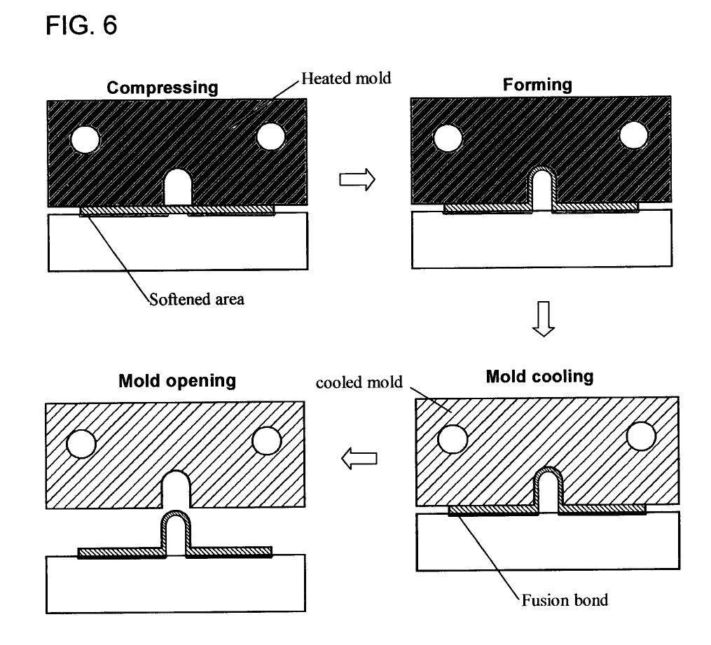

FIG. 6 schematically illustrates an embodiment to the present method for fabricating microchannels using a heated mold. An elevated mold temperature has two functions. First, it softens the film before the compressed air or vacuum is applied to deform the film blank against the mold pattern. Second, it softens the material at the film-to-substrate interface, thus forming thermal fusion bonds in-between. After microchannels are replicated on the film and fusion bonding is formed, the mold is cooled to below the softening temperatures of the film and the substrate. Separation of the cooled molding results in the needed microchannels. Rapidly heatable and coolable molds are preferred in this embodiment to minimize cycle time caused by the elevated mold temperature.

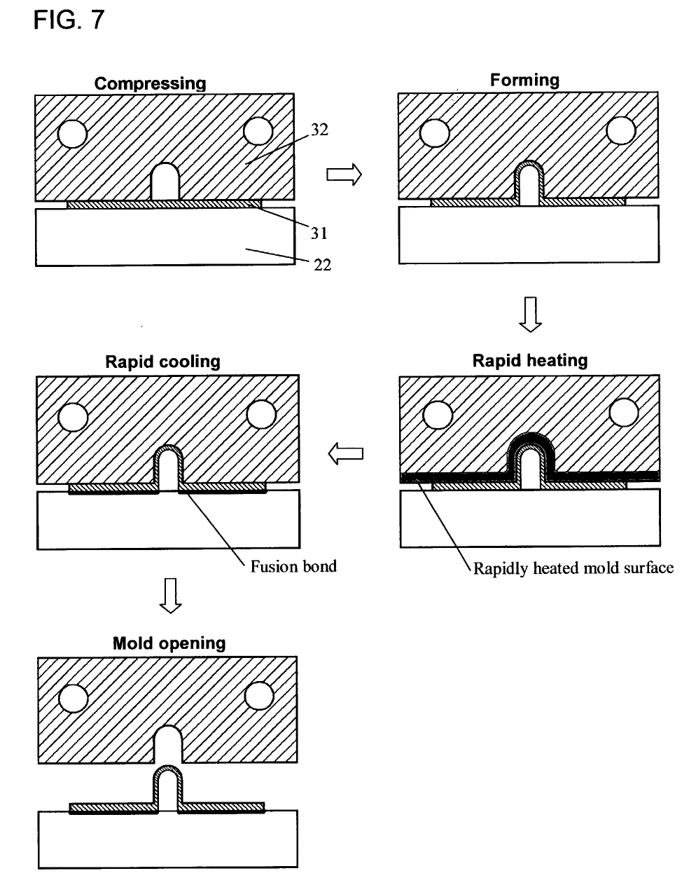

Embodiments to the present microchannel fabrication method using rapidly heatable and coolable molds have several variations, depending on when rapid heating and cooling is carried out. FIG. 7 schematically illustrates the preferable embodiment to the present method for fabricating microchannels when a rapidly heatable and coolable mold is employed. The sequence of operation involved in this special embodiment is summarized as follows. In the first step, the mold 32 clamps the thermoplastic film blank 31 against the substrate 22. The temperature of the die and the film is below the softening temperatures of the film and the substrate. In the second step, either compressed air is applied between the film and the substrate or vacuum is applied between the mold and the film to stretch and deform the film to replicate the microchannels on the mold. In the third step, while the air pressure or vacuum is maintained, the microstructured mold surface is rapidly heated to above the soften temperature of the film. The heated mold provides two functions. First, it softens the deformed film to convert any elastic deformation to plastic deformation. Second, it provides heat at the contact location between the film and the substrate, thus forming bonds between them. In the final step, the mold is rapidly cooled for the mold separation.

There are many modifications possible in the above described method for microchannel fabrication. For example compressed hot air can be utilized to blow the microchannel on the film. In this case, the film is softened by the heat carried in the hot air. After the blowing stage finishes, cool air or other cooling media can be used to displace the hot air to cool the film. Other modifications could be due to utilizing a separate process for bonding. For example, two molds can be employed to decouple the forming process from the bonding process. In doing so, the first mold is used to compress the film and form fusion between the film and the substrate. The second mold is used afterwards to form microchannels using compressed hot air.

### CONCLUSION, RAMIFICATIONS, AND SCOPE

Accordingly, the reader sees that microchannels can be formed between a thermoplastic film and a relatively thick substrate. The design for such microchannels is versatile and complicated layout of microchannel can be designed. The reader also sees that such microchannels can be fabricated using the integrated method combining compressing and blowing or vacuum forming, with judicious introduction of heat to soften the film and the area between the film and the substrate. The invention therefore provides a means for economical production of microchannels using thermoplastic materials.

While the above description contains many specificities these should not be construed as limitations on the scope of the invention, but rather as an exemplification of one preferred embodiment thereof. Many other variations are possible. Accordingly, the scope of the invention should be determined not by the embodiments illustrated, but by the appended claims and their legal equivalents.

What is claimed is:

1. A design of microchannels comprising
a) a plastic film and a relatively thick substrate with microchannels formed in-between
b) a means to bond said film to said substrate

2. The design of claim 1 wherein said film has thickness from a micron to a fraction of a millimeter.

3. The design of claim 1 wherein said substrate is made of a thermoplastic.

4. The design of claim 1 where said bond is formed using adhesives, solvents or thermal fusion.

5. A method for forming microchannels comprising the steps of:
a) placing a thermoplastic film onto a mold having the feature of microchannels
b) deforming the film to the shape of the channels by vacuum or blowing
c) opening the mold and removing the molded microchannels
whereby forming the film into the microfluidic channels and then sealing to the substrate.

6. The method of claim 5 wherein means of softening said film and the contact area between said film and said substrate is included.

7. The method of claim 6 wherein molds with rapid heating and cooling capability are employed
whereby rapid heating provides heat to soften said film and the contact area between said film and said substrate and rapid cooling provides short cycle times.

8. The method of claim 7 wherein said heating comprising the steps of:
a) passing a substantially high frequency alternating electric current through a portion of said mold half
b) passing the current through the other mold half
thereby heating selective surface areas of the mold by said proximity effect to a predetermined temperature.

9. The method of claim 7 wherein said heating is accomplished by infrared radiation, convective heating medium, or conduction to a heat source.

10. The method of claim 7 wherein said cooling is accomplished by passing a cooling medium to a portion of said mold.

11. The method of claim 10 wherein said cooling is accomplished rapidly by:
passing a cooling medium through a micro channel network that is located on the order of one millimeter below the inner surface of the molds
whereby a rapid cooling reduces the cooling time of the molding cycle.

12. The method of claim 11 wherein the cooling medium is displaced before the heating cycle begins,
whereby avoiding the heating of the cooling medium during the heating phase reduces the heating time and energy.

13. The method of claim 12 wherein the cooling medium is displaced by the pressure gradient of a gas.

14. The method of claim 9 wherein the displacing gas is air.

15. An apparatus of mold for fabricating microchannels, comprising:
a) softening means for the said plastic film
b) deforming means for the said plastic film to form microchannels between the said film and substrate.
c) bonding means between the said plastic film and the said substrate.

16. The apparatus of claim 15 wherein said means for softening the plastic film is achieved by rapidly heating the plastic film to above its softening temperature.

17. The apparatus of claim 15 wherein said means for deforming the plastic film is pressurized air.

18. The apparatus of claim 15 wherein said means for deforming the plastic film is vacuuming.

19. The apparatus of claim 15 wherein said means for forming a bond is achieved by rapidly heating the contact area of the film and the substrate to above the soften temperatures of both the film and the substrate.
